(19) United States
(12) Patent Application Publication
(10) Pub. No.: US 2005/0205767 A1
(43) Pub. Date: Sep. 22, 2005

(54) Safety switching apparatus

(76) Inventor: Jurgen Menz, Koln (DE)

Correspondence Address: NEXSEN PRUETT JACOBS & POLLARD, 201 W MCBEE AVENUE, SUITE 400, GREENVILLE, SC, 29601, US

(21) Appl. No.: 11/136,188

(22) Filed: May 24, 2005

Related U.S. Application Data
(63) Continuation of application No. 10/348,599, filed on Jan. 21, 2003.

(30) Foreign Application Priority Data
Jan. 23, 2002 (DE) 102 02 380.8

(51) Int. Cl. G01J 1/04; G06M 7/00

(52) U.S. Cl. 250/227.14; 250/221

(57) ABSTRACT

A safety switching apparatus for power-operated equipment, for power-operated machinery and for power-operated windows, doors, sliding equipment and the like, in particular of vehicles, having at least a light source, an optical waveguide (1), a light sensor and an associated control unit that controls the driving of the equipment in dependence on the intensity of light received by the light sensor, the optical waveguide (1) having a light-guiding core (2) with a high refraction coefficient and an outer wall (3) surrounding the light-guiding core (2) and having a lower refraction coefficient than the light guiding core (2), the light-guiding core (2) and/or the outer wall (3) being fabricated from a material that is in a liquid or elastically deformable state in the optical waveguide (1) ready for service.

### RELATED APPLICATIONS

This application is a continuation of U.S. patent application Ser. No. 10/348,599 filed Jan. 21, 2003 for a Safety Switching Apparatus.

### SPECIFICATION

The invention relates to a safety switching apparatus for power-operated equipment such as sliding gates, sliding grilles, elevating platforms, work platforms, work tables and the like, for power-operated machinery such as robots and driverless transport systems, and for power-operated windows, doors, sliding equipment and the like, such as used in vehicles.

### BACKGROUND OF THE INVENTION

Optical waveguides are generally known. They have also been described already as an element of a safety switching apparatus in the journal “f+h - - - fördern und heben,” 36 (1986) No. 2 beginning on page 106. The optical waveguide described in this publication in connection with driverless transport systems and robots has a core made of glass having a high refraction coefficient. An outer layer having a low refraction coefficient is arranged around the glass fiber and is in turn surrounded by a protective sheath. The light passes through the guide directly and via reflections at the boundary layer. In case of a sharp curvature of the guide, the light loses the ability to follow the sharp radii of the core. Part of the light escapes from the core and enters the outer layer. The low refraction coefficient means that the light cannot re-enter the core and is thus lost. The degree of curvature is therefore crucial with respect to the light loss. Because ordinary curvature of the optical waveguide due to compressive loading transverse to the optical waveguide is obviously not enough to produce light loss great enough that it can be used as a switching pulse by the light sensor, the cited document proposes winding a spiral made of a plastic around the protective sheath of the optical waveguide. If a pressure is now exerted, the spiral takes it up first and transfers it to the optical waveguide proper. The effect is an intensification of the curvature, which is then supposed to lead to a light loss such that the light sensor can detect this light loss as a switching pulse. Such an optical waveguide is therefore suitable for the low-loss guiding of light but less so as a switching element of a safety switching apparatus. It cannot satisfy the requirements of present-day power-operated equipment, machinery and the like because an unambiguous and also very rapidly detectable switching signal is supposed to be generated when even slight forces are applied to the optical waveguide.

For a safety switching apparatus on windows, A German patent application DE-37 31 428 A1 describes a mechanism that has an optical waveguide that is likewise wound with a spiral made of plastic. It is further stated there that the length “X” of a helical turn of the spiral in the longitudinal direction is preferably smaller than one finger's width. In this way the degree of curvature of the optical waveguide, which in this patent application is fabricated from acrylic glass, is supposed to be intensified. This switching apparatus or the use of the optical waveguide described there is also classed as inadequate for the reasons already set forth.

### OBJECTS AND SUMMARY OF THE INVENTION

It is an object of the invention to furnish for various applications a safety switching apparatus that satisfies all safety requirements and responds to slight pressure forces and in which even slight compressive forces lead to an unambiguous switching pulse.

The object of the invention is achieved in that the light-guiding core and/or the outer wall are fabricated from a material that is in a liquid or elastically deformable state in the optical waveguide ready for service. This fashioning of the light-guiding core and/or of the outer wall enables even relatively slight forces to lead to a change in the cross section of the light-guiding core and/or of the outer wall so that the intensity of light arriving at the light sensor changes. The optical waveguide according to the invention likewise guides light along the guide directly and via reflections at the boundary layer between the light-guiding core and the outer wall, the light-guiding core having a high refraction coefficient or refractive index so that guiding entails the lowest possible losses, and the outer wall having a lower refraction coefficient or a lower refractive index. According to the invention, the change in light guiding along the optical waveguide or the change in the intensity of light arriving at the light sensor is essentially brought about because the light-guiding core and/or the outer wall are elastically deformable and undergo elastic deformation when pressure is applied. Flexures of the optical waveguide naturally occur as well and also effect a change in the light losses. These, however, are less important. Because of the elasticity of the light-guiding core, the cross section of the light-guiding core changes under compressive loading in such a way that the light losses or the intensity of light reaching the light sensor decreases very rapidly. A similar effect also occurs if the outer wall is elastically deformed because the reflection at the compressed place changes as a result and light losses occur. The effects naturally add if both the light-guiding core and the outer wall are elastically deformable and change their cross sections as a result of compressive loading.

A spiral surrounding the optical waveguide can also be helpful in intensifying the pressure and thus partially the changes in cross section in the fashioning according to the invention. It is proposed according to the invention that the light-guiding core contains oil, resin or gel, in particular silicone gel. These materials have a high refraction coefficient or refractive index and are nevertheless deformable so that the cross section inside the outer wall deforms under compressive loading. The basic material of the resin or of the gel is liquid and free-flowing so that the material can be processed easily and can also be easily injected easily into the outer wall, curing or solidification then taking place without the formation of bubbles, so that an elastically compliant material is present afterward. In the case of oil that does not solidify or cure, care must be taken that the outer wall is tight and the oil cannot run out at the ends, appropriate closures being provided. It is therefore proposed that the light source and the light sensor have pluglike extensions that are sealingly inserted into the outer wall. It should be expressly stated that a liquid for optical light-wave connection (light-wave coupling), an optical liquid, a polymeric liquid, a liquid with adapted refractive index, wax, pastes or other plastics can be used as material for the light-guiding core in accord with the sense of the invention.

In further development of the invention, the outer wall is fashioned as a hose body preferably fabricated from a thermoplastic material. Such a thermoplastic hose body satisfies the requirement of a refraction coefficient or refractive index lower than that of the materials for the light-guiding core and can be fabricated and utilized in arbitrary lengths and sizes. This thermoplastic hose body is also elastically deformable so that a very strong change in light guiding along the guide occurs as a result of compression of this optical waveguide.

The outer wall can also be fabricated from an elastomeric or thermoplastically elastomeric material, from rubber, from a thermoplastic material, from a polymeric material or other plastic. It should be expressly stated that the invention is not limited to the materials described for the light-guiding core and the outer wall. All materials that satisfy the described requirements as to elasticity, manufacture and appropriate refraction coefficient, also called refractive index or index of refraction, can be employed. It is furthermore important that the materials for the light-guiding core and the outer wall be transparent or crystal-clear.

The hose body is advantageously surrounded or encompassed by a protective layer that affords protection against mechanical damage and protection against light loss from the core and against extraneous the entry of outside light to the core. In other words the protective layer reflects any core light passing radially through the outer wall back through the outer wall to the core. This protective layer must likewise be elastic and must not impair the elasticity of the light-guiding core and/or of the outer wall. In place of the outer wall fashioned as a hose body and the protective layer, it is also possible to use a protective layer or a protective body that has applied to its inside a material that forms the outer wall and assumes its function. Such an optical waveguide can also be extruded together integrally, for example in a triplex extrusion.

It is further proposed that the optical waveguide have a rectangular cross section that it can easily be associated with arbitrary closing edges. The optical waveguide can also be fashioned in tapelike or striplike form and can be adhesively attached to closing edges as adhesive strips. Either flat tapelike hose bodies can be used or also films that are laterally sealed before or after the charging of the material for the light-guiding core. It should be mentioned, however, that it is not categorically necessary to seal the films or tapes laterally after the application of the material for the light-guiding core, because the light can also be concentrated at the light source in such a way that lateral light losses are of secondary importance.

According to the method features of the invention, the optical waveguide can be fabricated by charging oil, resin or gel in free-flowing state into a hose, using pressure if appropriate, the resin or gel subsequently being solidified or cured to an elastically deformable mass. Such a solidification or curing is possible without the formation of small bubbles that could interfere with light guiding. An adhesive attachment of the gel or resin to the inner wall of the hose moreover takes place so that such an optical waveguide can be arbitrarily portioned.

Films can be used for the fabrication of tapelike or striplike optical waveguides, the light-guiding material being applied to one side of one film, the other film being placed thereover so that the light-guiding material is sandwiched between the two films to form a composite. Striplike or tapelike optical waveguides are separated or cut off after the curing or solidification of the light-guiding material. One of the films can also be provided with an adhesive material or strip so that simple and economical attachment of such an optical waveguide to a closing edge is possible.

### BRIEF DESCRIPTION OF THE DRAWINGS

The invention is further explained with reference to a preferred embodiment of the invention as depicted in simplified form in the drawings, in which:

FIG. 1 is a cross section through an optical waveguide realized in round form and

FIG. 2 is a partial cross section along line II-II in FIG. 1.

### DETAILED DESCRIPTION OF THE INVENTION

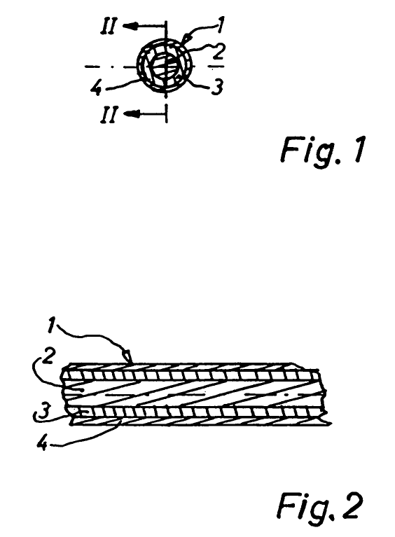

In FIGS. 1 and 2, insofar as shown in detail, 1 generally identifies an optical waveguide having a light-guiding core 2 and an outer wall 3 fashioned as a hose body. Light-guiding core 2 is formed of oil, cured resin or solidified gel, in particular silicone gel, these materials being inserted in the liquid state into the outer wall 3 fashioned as a hose body. It should be expressly stated that an appropriate optical waveguide can also be fabricated otherwise, for example by extrusion. Applied around the outer wall 3 for protection against damage and also for protection against the entry or escape of light is a protective layer 4 that can likewise be realized as an elastic hose or also as a coating or covering. The optical waveguide is depicted with a circular cross section in the Figures. It should, however, be understood that an oval cross section or a quadrilateral cross section can be provided, depending on the application. Still other cross-sectional shapes can also result from two or more optical waveguides being attached to each other or combined into structural units, for example via the outer walls.

1. An optical waveguide for safety switching apparatus controlled by changes in the intensity of light passing through the optical wave guide comprising:
a crystal-clear silicon gel light-guiding core having a refraction coefficient and
a hose shaped outer wall of crystal-clear elastomeric thermoplastic material encompassing said light-guiding core, said outer wall having a lower refraction coefficient than said light-guiding core and said light-guiding core and said outer wall being flexible thereby permitting flexing of said wave guide to change the intensity of light passing through said waveguide.

2. The waveguide of claim 1 wherein said core is an elastically deformable plastic.

3. The waveguide of claim 1 wherein said outer wall is a gel.

4. The waveguide of claim 1 having a protective layer of elastic material surrounding said outer wall, said protective layer preventing radial loss of light from said waveguide.

5. The waveguide of claim 4 wherein upon changes in cross section of either of said core and outer wall said protective layer reflects the reflected light back through the outer wall and to the core.

6. A method of fabricating an optical waveguide comprising the steps of:
providing a hollow outer wall (3);
forming a light guiding core by inserting a gel under pressure into said hollow outer wall (3) and
curing said gel into an elastically deformable mass inside said outer wall.

7. The method of claim 6 wherein said light guiding core has a high refraction coefficient and said outer wall is fabricated from a material having a lower refraction coefficient than said light guiding core (2).

8. A method of fabricating tapelike optical waveguides, comprising the steps of:
providing a first film,
applying a light guiding gel material on said first film,
placing a second film on top of said gel material to form a composite,
curing said light guiding gel and
cutting said composite into tapelike strips.

9. The method of claim 8 wherein said light guiding film has a high refraction coefficient and said first and second films have a refraction coefficient lower than said refraction coefficient of said light guiding film.

10. The method of claim 9 and further comprising the step of placing an adhesive material on one side of said composite.
